(19) United States
(12) Patent Application Publication
(10) Pub. No.: US 2007/0012758 A1
(43) Pub. Date: Jan. 18, 2007

(54) Device and method for recording financial information

(76) Inventor: Wanda J. Wilson, Wapato, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/416,952

(22) Filed: May 3, 2006

Related U.S. Application Data
(60) Provisional application No. 60/699,793, filed on Jul. 14, 2005.

(51) Int. Cl. G07F 19/00

(52) U.S. Cl. 235/379

(57) ABSTRACT

A device for recording financial transactions, comprising a control system, a display and a manual input system, the manual input system comprising a plurality of function inputs, a plurality of account selection inputs, a plurality of category selection inputs and a plurality of numerical data inputs.

### BACKGROUND OF THE INVENTION

1. Field of the Invention

The present disclosure is directed to a device and method for recording financial information, and, more particularly, to a portable device and method to track resources and/or expenses for budgeting purposes.

2. Description of the Related Art

Prior art devices for keeping track of expenses and available or allocated resources are expensive and complicated to use, and often have limited portability. For example, devices such as conventional computers can be programmed to store information regarding account balances and expenses. Conventional computers, however, are expensive and not always portable. In addition, a user must learn how to use the computer, in addition to learning how to use a program to keep track of the desired information. Conventional portable computers, and personal computing devices such as hand-held portable digital assistants also are expensive, tend to have limited battery life, and also require the user to learn both the operating system of the device and a program to keep track of the desired information. Such devices also frequently require the user to interface with a conventional computer to retrieve or store data and/or to configure the device for the desired use. Hand-held calculators can be used to tally expenses and deposits, but only expensive models can be configured to store information in a readily retrievable and updateable manner, and they also are difficult to use and require a user to learn how to use the calculator and how to program the calculator to store and retrieve data.

Accordingly, it can be appreciated that there is a need for a budget tracking device and method that is portable, flexible, inexpensive and easy to use.

### BRIEF SUMMARY OF THE INVENTION

The present disclosure is directed to an inexpensive and highly portable device for recording financial transactions for budgeting purposes. In some embodiments, the device is highly suitable for budget training programs. In some embodiments, the device is highly useful for tracking monthly expenses or travel expenses. Some embodiments may have limited capabilities to keep the cost low. Some embodiments may perform limited calculator functions.

In one embodiment, a device for recording financial transactions comprises a housing; a control system coupled to the housing and having a memory; a display coupled to the housing; and an input system coupled to the housing, the input system comprising: a plurality of manual switches configured to receive function data; a plurality of manual switches configured to receive account selection data; a plurality of manual switches configured to receive category selection data; and a plurality of manual switches configured to receive numerical data. In one embodiment, the control system comprises an eight-bit processor. In one embodiment, the control system comprises a sixteen-bit processor. In one embodiment, the input system comprises a plurality of keys on a keypad. In one embodiment, the plurality of switches configured to receive category selection data comprises a portion of the plurality of keys on the keypad. In one embodiment, categories of the category selection keys on the keypad are fixed. In one embodiment, the device is configured to perform calculator functions. In one embodiment, the keys on the keypad are not re-assignable. In one embodiment, the plurality of switches configured to receive function data comprises an off key; an on/CE key; an enter key; a clear all key; a deposit key; a balance key; a total key; an addition key; a subtraction key; a multiplication key; and a division key. In one embodiment, the plurality of switches configured to receive function data further comprises a percent key; and a day key. In one embodiment, the plurality of switches configured to receive account selection data comprises: a credit account selection key; an ATM account selection key; a cash account selection key; a checking/debit account selection key; and a budget account selection key. In one embodiment, the plurality of switches configured to receive category selection data comprises: a fun category selection key; a clothing category selection key; a housing category selection key; a personal care category selection key; a grocery category selection key; a utilities category selection key; and a transportation category selection key.

In one embodiment, a method of recording a financial transaction performed by a computing device comprises receiving a financial transaction input sequence associated with the financial transaction from a plurality of keys on a keypad of the computing device; associating an account with the financial transaction based on the received financial transaction input sequence; associating an expense category with the financial transaction based on the received financial transaction input sequence; displaying information associated with the financial transaction on a display of the computing device; and storing information associated with the financial transaction in a memory of the computing device, the stored information including a reference to the associated account and a reference to the associated expense category. In one embodiment, the method further comprises clearing the stored information from the memory in response to a clear input sequence received from the keypad of the computing device. In one embodiment, the method further comprises performing a calculator function in response to a calculator input sequence received from the keypad of the computing device. In one embodiment, the storing information associated with the financial transaction in the memory of the computing device comprises storing the information in a data record in the memory of the computing device.

In one embodiment, a device for recording financial transactions, comprises a housing; means for receiving a financial transaction input sequence associated with the financial transaction coupled to the housing; means for associating an account with the financial transaction based on the received financial transaction input sequence contained within the housing; means for associating an expense category with the financial transaction based on the received financial transaction input sequence contained within the housing; means for displaying information associated with the financial transaction coupled to the housing; and means for storing information associated with the financial transaction contained within the housing, the stored information including a reference to the associated account and a reference to the associated expense category.

### BRIEF DESCRIPTION OF THE SEVERAL VIEWS OF THE DRAWINGS

The foregoing and other features and advantages of the present invention will be more readily appreciated as the same become better understood from the following detailed description when taken in conjunction with the accompanying drawings, wherein:

FIG. 1 is a functional block diagram of an embodiment of a device for recording financial information;

FIG. 2 is a top plan view of an embodiment of a device for recording financial information;

FIG. 3 is a top plan view of another embodiment of a device for recording financial information;

FIG. 4 is a flow diagram illustrating an embodiment of a method of operating a device for recording financial information;

FIG. 5 is a flow diagram illustrating an embodiment of a method of operating a device for recording financial information; and

FIG. 6 is an example embodiment of a record of a financial transaction that may be stored in a memory of an embodiment of a device for recording financial information.

### DETAILED DESCRIPTION OF THE INVENTION

The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not necessarily intended to convey any information regarding the actual shape of particular elements, and have been selected solely for ease of recognition in the drawings.

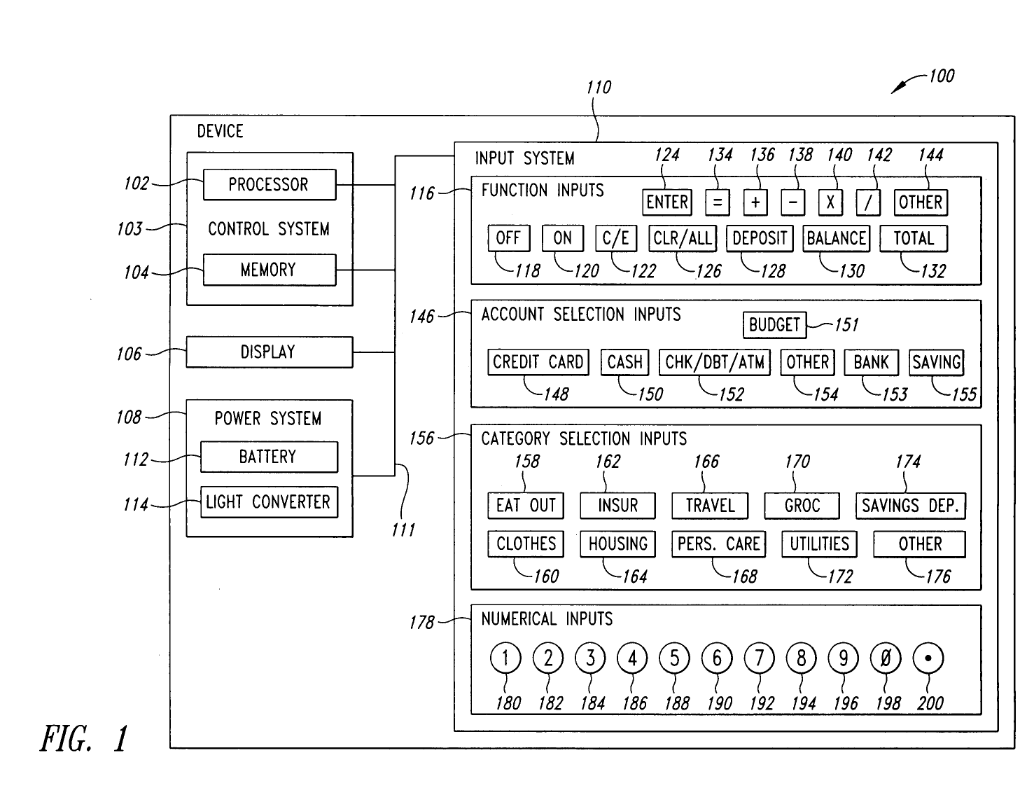

FIG. 1 is a functional block diagram of an embodiment of a device 100 for recording financial information. The device 100 comprises a control system 103 comprising a processor 102, which controls operation of the device 100, and a memory 104. The processor 102 may take the form of one or more inexpensive, standard processors, such as a standard eight-bit processor or a 16-bit processor, firmware, a digital signal processor, an application specific integrated circuit or other circuitry and components or combinations thereof, with or without associated memory. The memory 104 may comprise, for example, registers, read only memory (“ROM”), random access memory (“RAM”), flash memory and/or electronically erasable programmable read only memory (“EEPROM”), and may provide instructions and data for use by the device 100. For example, the memory 104 may store financial information, such as account balances and transactional histories, in one or more data structures. In some embodiments, the memory 104 is designed to be large enough to store a number of transactions an average user would enter in a month, but not much larger. This facilitates keeping the cost of the device 100 low, while providing an embodiment that may be advantageously employed to track monthly expenses.

The device 100 also comprises a display 106, a power system 108, an input system 110 and a bus system 111. The display 106 may comprise an alpha-numeric display, such as an inexpensive LED display. The device 100 is configured to display alpha-numeric data entered by a user and/or retrieved from the memory 104 in response to commands from the processor 102. In some embodiments, the display 106 may be configured to display only numeric information. In other embodiments, the display 106 may be configured to display other information as well as numeric information, as discussed in more detail below.

The power system 108 as illustrated comprises a battery 112 and a light converter 114, such as a solar cell. The power system 108 provides power to the device 100.

The input system 110 receives input from a user, which may be used by the device 100. For example, the device 100 may record, process, store and display financial information based on input received from the input system 110, as discussed in more detail below. As illustrated, the input system 110 comprises a function input system 116, an account selection input system 146, a category selection input system 156, and a numerical input system 178.

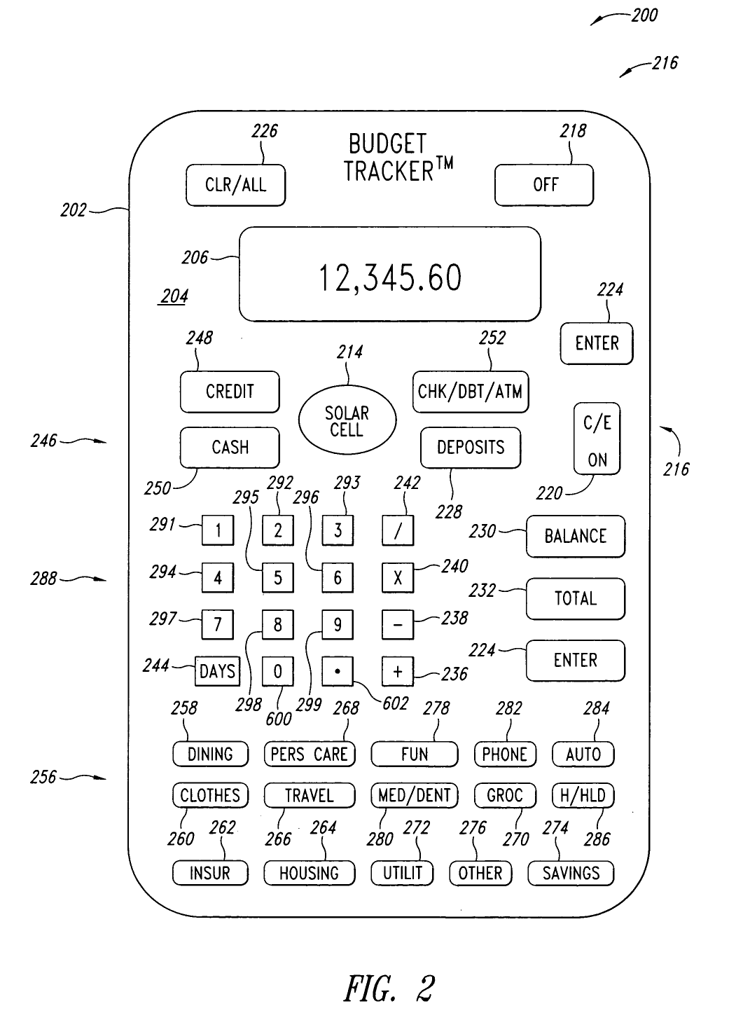

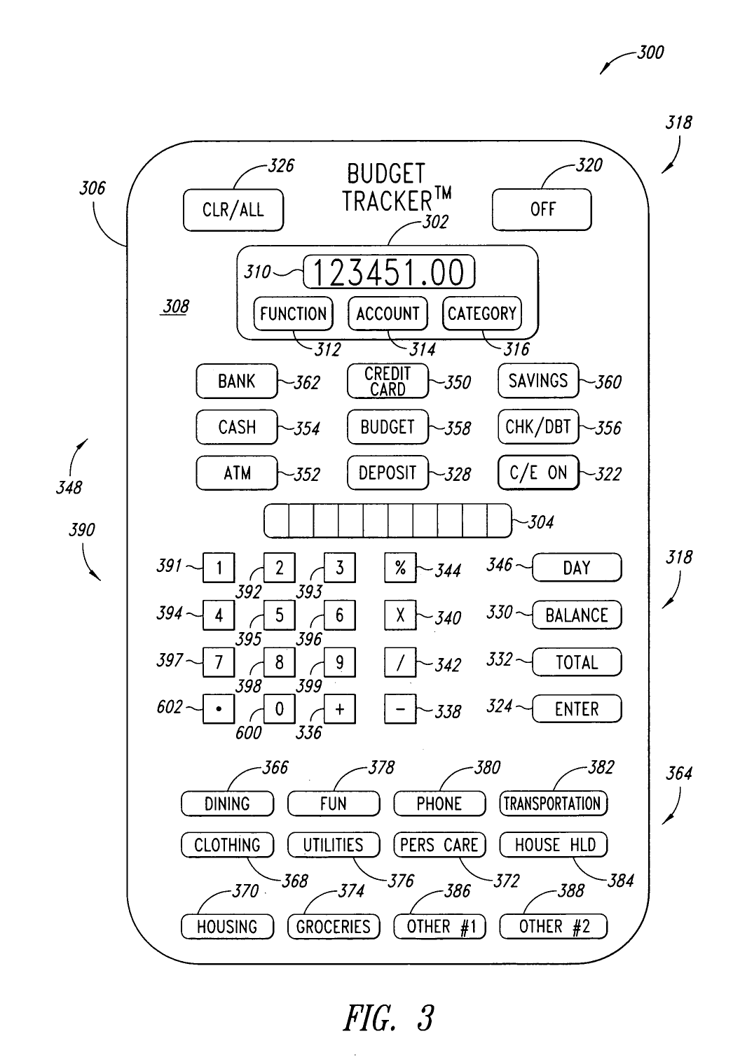

The function input system 116 as illustrated comprises a plurality of function control inputs for manually selecting a function, including a turn off input 118, a turn on input 120, a clear entry input 122, an enter input 124, a clear-all input 126, a deposit input 128, a balance input 130, a total input 132, an equals (illustrated as “=”) input 134, an addition (illustrated as “+”) input 136, a subtraction (illustrated as “−”) input 138, a multiplication (illustrated as “x”) input 140, a division (illustrated as “/”) input 142, and an optional function control input for selecting other functions 144 (for example, a set time or a set alarm input). The inputs 118-144 of the function input system 116 may take the form of switches, such as input keys on a keypad (see FIGS. 2 and 3), or slide switches. The function input system 116 may contain additional or fewer function control inputs. In some embodiments, some inputs of the function input system 116 may be combined with other inputs. For example, in some embodiments, the enter input 124 and the equals input 134 may be combined into a single input. In another example, the on input 120 may be combined with the clear entry input 122.

The account selection input system 146 as illustrated comprises a plurality of account selection inputs for manually identifying an account, including a credit account selection input 148, a cash account selection input 150, a budget account selection input 151, a check/debit/ATM account selection input 152, a bank account selection input 153, a savings account selection input 155 and an optional input for selecting other accounts 154. The inputs 148-155 of the account selection input system 146 may take the form of switches, such as input keys on a keypad (see FIGS. 2 and 3). In some embodiments, the account selection inputs 148-155 may be abstract, instead of assigned to specific accounts (i.e., account 1, account 2, account 3, etc.). In such embodiments, a label may be employed to identify the account. In some embodiments, a single input may toggle between selected accounts, and in such embodiments the selected account may be indicated by the display 106. The account selection input system 146 may contain additional or fewer account selection inputs. For example, some embodiments may not comprise a savings account selection input 155. In some embodiments, some inputs of the account selection input system 146 may be combined and/or separated in a manner different from the illustrated embodiment. For example, in some embodiments, the check/debit/ATM selection input 152 may be split into separate account selection inputs.

The expense category selection input system 156, as illustrated in FIG. 1, comprises a plurality of expense category selection inputs for manually identifying an expense category, including an eating-out expense category selection input 158, a clothes expense category selection input 160, an insurance expense category selection input 162, a housing expense category selection input 164, a travel expense category selection input 166, a personal care expense category selection input 168, a grocery expense category selection input 170, a utilities expense category selection input 172, a savings deposit expense category selection input 174, and an other expense category selection input 176. The expense category selection inputs 158-176 of the expense category selection input system 156 may take the form of switches, such as input keys on a keypad (see FIGS. 2 and 3). In some embodiments, the expense category selection inputs 158-176 may be abstract, instead of assigned to specific categories (i.e., category 1, category 2, category 3, etc.). In such embodiments, a label, which may or may not be removable, such as a sticker, may be employed to identify the expense category.

In some embodiments, a single input may toggle between selected expense categories, and the selected expense category may be indicated by the display 106. The category selection input system 156 may contain additional expense category selection inputs. For example, some embodiments may contain an automobile expense category selection input. In another example, some embodiments may contain a fun expense category selection input. In some embodiments, some inputs of the expense category selection input system 156 may be combined and/or separated in a manner different from the illustrated embodiment. For example, in some embodiments, the utility expense selection input 172 may be split into separate inputs (i.e., phone, gas, electric).

The numerical input system 178 comprises a plurality of inputs for manually entering numerical data. As illustrated, the numerical input system comprises an input for the number 1 (illustrated as “1”) 180, an input for the number 2 (illustrated as “2”) 182, an input for the number 3 (illustrated as “3”) 184, an input for the number 4 (illustrated as “4”) 186, an input for the number 5 (illustrated as “5”) 188, an input for the number 6 (illustrated as “6”) 190, an input for the number 7 (illustrated as “7”) 192, an input for the number 8 (illustrated as “8”) 194, an input for the number 9 (illustrated as “9”) 196, an input for zero (illustrated as “0”) 198 and a decimal input (illustrated as “.”) 200. The inputs 180-200 of the numeric input system 178 may take the form of switches, such as input keys on a keypad (see FIGS. 2 and 3), or slide switches.

The bus system 111 may comprise a power bus, control bus, and status signal bus in addition to a data bus. For the sake of clarity, however, the various system buses are illustrated in FIG. 1 as the bus system 111. Details of the connections of the bus system 111 to the components of the control system 103, the power system 108 and the input system 110 are omitted for clarity of illustration.

The operations to be performed in response to the activation of some of the various inputs (i.e., in response to pressing a key or a sequence of keys, or the setting of a slide or toggle switch) are discussed in more detail below using illustrative examples. The operations performed in response to other inputs and input sequences will be readily understood by one of skill in the art reviewing the specification (i.e., two numerical sequences separated by the addition function input).

FIG. 2 is a top plan view of an embodiment of a device 200 for recording financial information. The device 200 comprises a display 206, a solar cell 214, a housing 202, and a keypad 204 comprising a plurality of input keys. The plurality of input keys illustrated in FIG. 2 includes a set of function input keys 216 comprising an off key 218, an on/CE key 220, two enter keys 224, a clear-all key 226, a deposits key 228, a balance key 230, a total key 232, an addition key 236, a subtraction key 238, a multiply key 240, a divide key 242 and a days keys 244. The plurality of input keys illustrated in FIG. 2 includes a set of account selection keys 246 comprising a credit account selection key 248, a cash account selection key 250 and a checking/debit/ATM account selection key 252. The plurality of input keys illustrated in FIG. 2 includes a set of category selection keys 256 comprising a dining category selection key 258, a clothes category selection key 260, an insurance category selection key 262, a housing category selection key 264, a travel category selection key 266, a personal care category selection key 268, a grocery category selection key 270, a utilities category selection key 272, a savings category selection key 274, a category selection key for other categories 276, a fun category selection key 278, a medical/dental category selection key 280, a phone category selection key 282, an automobile category selection key 284, and a household category selection key 286. The plurality of input keys illustrated in FIG. 2 includes a set of numeric data input keys 288 comprising an input key 291 for the number 1 (illustrated as “1,”), an input key 292 for the number 2 (illustrated as “2”), an input key 293 for the number 3 (illustrated as “3”), an input key 294 for the number 4 (illustrated as “4”), an input key 295 for the number 5 (illustrated as “5”), an input key 296 for the number 6 (illustrated as “6”), an input key 297 for the number 7 (illustrated as “7”), an input key 298 for the number 8 (illustrated as “8”), an input key 299 for the number 9 (illustrated as “9”), an input key 600 for zero (illustrated as “0”) and a decimal input key (illustrated as “.”) 602.

FIG. 3 is a top plan view of another embodiment of a device 300 for recording financial information. The device 300 comprises a display 302, a solar cell 304, a housing or case 306, and a keypad 308 comprising a plurality of input keys. The display 302 as illustrated comprises a main display portion 310, a function display portion 312, an account display portion 314, and a category display portion 316. The main display portion 310 may be configured to display data as it is entered, results or retrieved data, error messages, and queries, such as requests for verification of a command, such as a clear-all function command.

The plurality of input keys illustrated in FIG. 3 includes a set of function input keys 318 comprising an off key 320, an on/CE key 322, an enter key 324, a clear-all key 326, a deposit key 328, a balance key 330, a total key 332, an addition key 336, a subtraction key 338, a multiplication key 340, a division key 342, a percent key 344, and a day key 346. The plurality of input keys illustrated in FIG. 3 includes a set of account selection keys 348 comprising a credit account selection key 350, an ATM account selection key 352, a cash account selection key 354, a checking/debit account selection key 356, a budget account selection key 358, a savings account selection key 360, and a bank account selection key 362. The plurality of input keys illustrated in FIG. 3 includes a set of category selection keys 364 comprising a dining category selection key 366, a clothing category selection key 368, a housing category selection key 370, a personal care category selection key 372, a grocery category selection key 374, a utilities category selection key 376, a fun category selection key 378, a phone category selection key 380, a transportation category selection key 382, a household category selection key 384, and two category selection keys for other categories 386, 388. The plurality of input keys illustrated in FIG. 3 includes a set of numeric data input keys 390 comprising an input key 391 for the number 1 (illustrated as “1”), an input key 392 for the number 2 (illustrated as “2”), an input key 393 for the number 3 (illustrated as “3”), an input key 394 for the number 4 (illustrated as “4”), an input key 395 for the number 5 (illustrated as “5”), an input key 396 for the number 6 (illustrated as “6”), an input key 397 for the number 7 (illustrated as “7”), an input key 398 for the number 8 (illustrated as “8”), an input key 399 for the number 9 (illustrated as “9”), an input key 600 for zero (illustrated as “0”) and a decimal input key (illustrated as “.”) 602.

In some embodiments, some of the keys illustrated in FIGS. 2 and 3 may be replaced with other user-activated switches. For example, the off key 118, 320 may be replaced with a slide switch that turns the device on and off, and the on/CE key 220, 322 may be replaced with a CE key, to reduce the likelihood that the device 200, 300 would inadvertently be switched on and/or off. In some embodiments an input may be time sensitive. For example, in some embodiments the clear-all key 226, 326 may clear an entry if depressed briefly, and may clear all data in the device, or all data associated with a particular account, if depressed for an extended period of time, or if activated as part of an input sequence. For example, in some embodiments depressing the clear-all key for three seconds might clear any transactions stored in the memory (see memory 104 in FIG. 1) of the device 200, 300. In this manner, embodiments of the device 100, the device 200 or the device 300 may be advantageously employed to track budgetary information over a defined period of time, such as a month. At the beginning of a new month, the transactions for the previous month could be cleared by depressing and holding the clear-all button 226, 326 for three seconds. In some embodiments, confirmation of a clear-all command may be required.

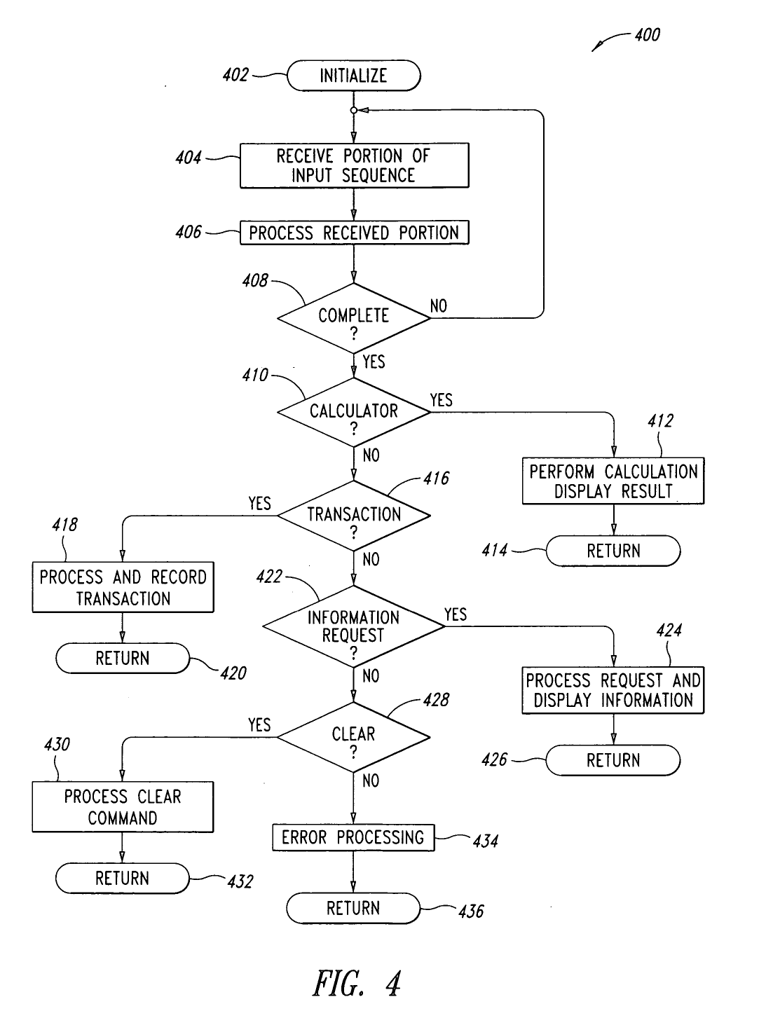

FIG. 4 is a flow diagram illustrating an embodiment of a subroutine 400 for processing a user input sequence that may be employed by an embodiment of a device for recording financial information, such as the device 100 illustrated in FIG. 1, the device 200 illustrated in FIG. 2, or the device 300 illustrated in FIG. 3. For convenience, FIG. 4 will be described in terms of the device 100 illustrated in FIG. 1.

The device 100 initializes the subroutine at 402. The subroutine 400 proceeds from 402 to 404. At 404, the device receives at least a portion of an input sequence, such as an account selection, a category selection, an operand, numeric data, or a function selection. The subroutine 400 proceeds to 406. At 406, the device 100 processes the received portion, which may include displaying the received portion of the input sequence and/or setting the value of variables. For example, if a checking account selection input was received, the device 100 might store an indication that the input sequence relates to the checking account.

The subroutine proceeds to 408, where the device 100 determines whether the input sequence is complete. This may be done in some embodiments by, for example, determining whether a function selection has been made or a complete calculator sequence has been entered. If it is determined at 408 that a complete input sequence has not been entered, the subroutine 400 returns to 404, where the device 100 is configured to receive additional input. If it is determined at 408 that a complete input sequence has been received, the subroutine 400 proceeds to 410.

At 410, the device 100 determines whether the input sequence corresponds to a request to perform a calculator function. This may be done in some embodiments by, for example, determining whether an arithmetic operand key was received in the input sequence. When it is determined at 410 that the input sequence corresponds to a request to perform a calculator function, the subroutine 400 proceeds to 412, where the device 100 performs the requested calculator function and displays the result. The subroutine 400 proceeds to 414, where the subroutine 400 terminates and returns the value of any desired variables.

When it is determined at 410 that the input sequence does not correspond to a request to perform a calculator function, the subroutine 400 proceeds to 416. At 416, the device 100 determines whether the input sequence corresponds to a request to record a financial transaction, such as a request to record a balance or a request to record an expenditure, such as a check written to purchase clothing. The device 100 may record a transaction by storing data, such as a reference to an account associated with the transaction and a reference to an expense category associated with the transaction, in a transaction data record stored in the memory 104. Examples of input sequences that correspond to request to record a financial transaction are presented below. In some embodiments, the device 100 might employ a look-up table to determine whether the request corresponds to a request to record a financial transaction. When it is determined at 416 that the request corresponds to a request to record a financial transaction, the subroutine 400 proceeds to 418.

At 418, the device processes the sequence and records the financial transaction. In some embodiments, a look-up table may be employed to process the sequence and record the financial transaction. Examples of processing a sequence and recording a corresponding financial transaction are discussed below. Processing the sequence and recording an associated financial transaction may include displaying information on a display, such as the display 106. Processing the sequence and recording an associated financial transaction may include storing one or more transaction data records in a memory, such as the memory 104. The subroutine 400 proceeds from 418 to 420, where the subroutine 400 terminates and returns the value of any desired variables, such as the amount of the transaction, the expense category, if applicable, and any revised account balances.

When it is determined at 416 that the input sequence does not correspond to a request to record a financial transaction, the subroutine 400 proceeds to 422. At 422, the device 100 determines whether the input sequence corresponds to a request for information, such as a request for the balance of an account or total amount spent in an expense category. When it is determined at 422 that the input sequence corresponds to a request for information, the subroutine 400 proceeds to 424. At 424, the device 100 processes the request for information and displays the requested information. A look-up table may be employed by the device 100 to control processing of the information request. Examples of input sequences that correspond to information requests are discussed below. The subroutine 400 proceeds from 424 to 426, where it terminates and returns the value of any desired variables.

When it is determined at 422 that the input sequence does not correspond to a request for information, the subroutine 400 proceeds to 428. At 428, the device 100 determines whether the input sequence corresponds to a clear command. In some embodiments, this may be done by, for example, determining whether the input sequence includes a clear command. When it is determined at 428 that the input sequence corresponds to a clear command, the subroutine 400 proceeds to 430. At 430, the device 100 processes the clear command, which may be, for example, a command to clear the input sequence, a command to clear an account balance, a command to clear transactions in an expense category, or a command to clear all stored transactions and account balances. Processing a clear command may include determining whether an input, such as the clear-all input 126, was activated for a threshold period of time. The device 100 may employ a look-up table to process the clear command. The subroutine 400 proceeds from 430 to 432, where it terminates and returns the value of any desired variable.

When it is determined at 428 that the input sequence does not correspond to a clear command, the subroutine 400 proceeds to 434, where the device 100 performs error processing. The error processing may constitute, for example, clearing the input sequence and displaying an error message. The subroutine 400 proceeds from 434 to 436, where it terminates and returns the value of any desired variables.

Embodiments of the method discussed in FIG. 4 may contain additional acts not shown in FIG. 4, may not contain all of the acts shown in FIG. 4, may perform acts shown in FIG. 4 in various orders, may call subroutines, and may combine acts shown in FIG. 4. For example, the embodiment illustrated in FIG. 4 may be modified to determine whether an input sequence corresponds to a calculator function request after determining whether an input sequence corresponds to a request to record a financial transaction. In another example, the embodiment illustrated in FIG. 4 may be modified to include error processing in the event a financial transaction would result in a negative balance in an account. For example, if a user attempted to record a check written for an amount in excess of the balance of a checking account, the subroutine 400 might generate an appropriate message indicating the account was overdrawn.

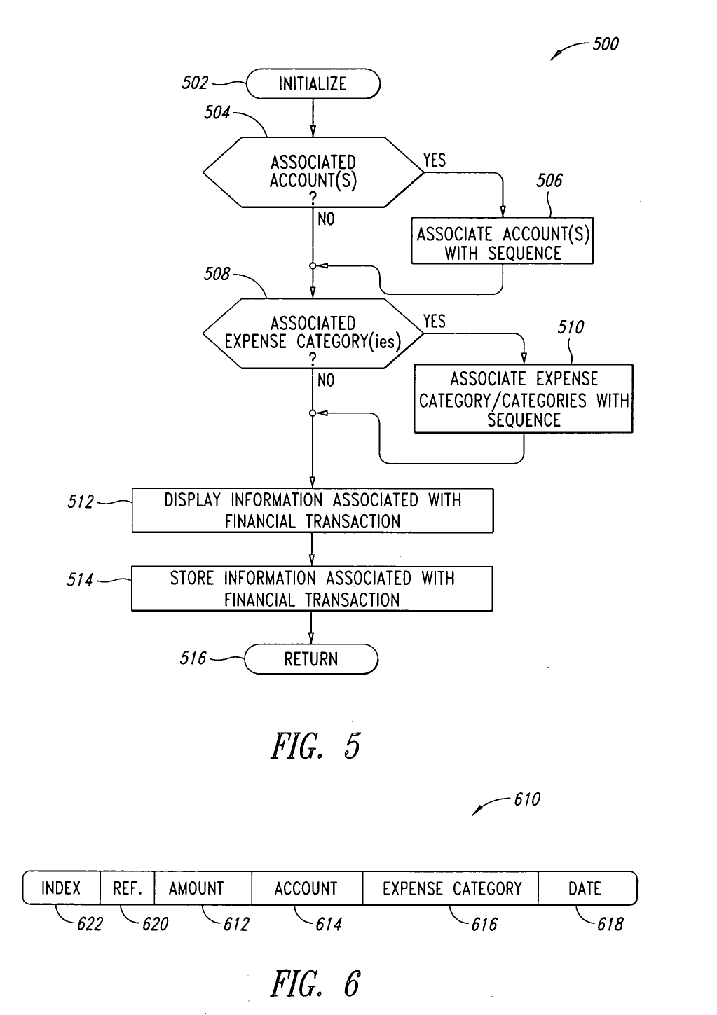

FIG. 5 is a flow diagram illustrating an embodiment of a subroutine 500 for processing and recording a user input sequence that may be employed by an embodiment of a device for recording financial information, such as the device 100 illustrated in FIG. 1, the device 200 illustrated in FIG. 2, or the device 300 illustrated in FIG. 3. The subroutine 500 may be called, for example, by the embodiment of a subroutine illustrated in FIG. 4. For convenience, FIG. 5 will be described in terms of the device 100 illustrated in FIG. 1.

The device 100 initializes the subroutine at 502. The subroutine 500 proceeds from 502 to 504. At 504, the device 100 determines whether the financial transaction input sequence is associated with one or more accounts, such as a bank account, a savings account, or a credit card account. This may be done, for example, by determining whether the input sequence includes one or more account selections. Default account selections may be employed. The device 100 may employ a look-up table to determine whether the input sequence is associated with one or more accounts.

When it is determined that the financial transaction input sequence is associated with one or more accounts, the subroutine 500 proceeds from 504 to 506. When it is determined that the financial transaction input sequence is not associated with an account, the subroutine 500 proceeds from 504 to 508. At 506, the device 100 associates the financial transaction with one or more accounts. This may be done, for example, by setting flags or variables. The subroutine 500 proceeds from 506 to 508.

At 508, the device 100 determines whether one or more expense categories are associated with the financial transaction input sequence. This may be done, for example, by determining whether the input sequence includes one or more expense category selections. Default expense category selections may be employed. The device 100 may employ a look-up table to determine whether the input sequence is associated with one or more expense categories.

When it is determined that the financial transaction input sequence is associated with one or more expense categories, the subroutine 500 proceeds from 508 to 510. When it is determined that the financial transaction input sequence is not associated with an expense category, the subroutine 500 proceeds from 508 to 512. At 510, the device 100 associates the financial transaction with one or more expense categories. This may be done, for example, by setting flags or variables. The subroutine 500 proceeds from 510 to 512.

At 512, the device 100 displays information associated with the financial transaction. The subroutine 500 proceeds from 512 to 514. At 514, the device 100 stores information associated with the financial transaction. The stored information may include a reference to any associated accounts and a reference to any associated expense categories. The device 100 may employ one or more financial transaction data records (see FIG. 6) to store the information associated with the financial transaction. The subroutine 500 proceeds from 514 to 516. At 516, the subroutine 500 terminates and returns the value of any desired variables, such as, for example, the amount of the transaction, the expense category, if applicable, and any revised account balances.

Embodiments of the subroutine 500 discussed in FIG. 5 may contain additional acts not shown in FIG. 5, may not contain all of the acts shown in FIG. 5, may perform acts shown in FIG. 5 in various orders, may call subroutines, and may combine acts shown in FIG. 5. For example, the embodiment illustrated in FIG. 5 may be modified to include error processing in the event a financial transaction would result in a negative balance in an account.

FIG. 6 illustrates an example transaction data record 610 for storing information associated with a financial transaction. The transaction data record 610 comprises a plurality of fields, which as illustrated include an amount field 612, an account field 614, an expense category field 616, a date field 618, a reference field 620 and an index field 622. A transaction data record may contain additional fields, and may not contain all of the fields illustrated in FIG. 6. For example, a transaction data record 610 may contain two account fields 614. In another example, a transaction data record 610 may not contain a reference field 620 or may contain more than one reference field for storing reference numbers, which may store, for example, a check number. The transaction data record 610 may be linked to other transaction data records and may be indexed or linked to one or more indexes. A financial transaction may be associated with one or more transaction data records, such as the data record 610. For example, some embodiments may record an ATM withdrawal in two transaction records. For example, a first transaction record may record a debit or decrease to a checking balance and a second transaction record may record an increase in a cash balance. Embodiments of a device for recording financial information, such as the devices 100, 200, 300 illustrated in FIGS. 1-3, may employ more than one type of data record. For example, other types of data records may record account balances, changes to account balances, or both.

Operation of an embodiment of a device for recording financial information, such as the embodiments 100, 200, 300 illustrated in FIGS. 1-3, will be further illustrated below using a limited number of examples. The examples should be viewed as illustrative, rather than as mandatory examples. In other words, an example may illustrate an input sequence for recording a check written on a checking account. Some embodiments may employ other or additional input sequences for recording a check written on a checking account. Examples described with respect to one embodiment (i.e., the embodiment of a device 200 illustrated in FIG. 2) may be applicable to other embodiments (i.e., the embodiments 100, 300 illustrated in FIGS. 1 and 3, respectively).

Illustrative examples of the operation of a device for recording financial transactions are described below with reference to the embodiment of the device 200 of FIG. 2.

In some embodiments, a checking account balance from a monthly banking statement may be entered by pressing the checking/debit/ATM key 252 to identify the account, pressing the balance key 230 to indicate that the transaction involves a balance, enter the balance amount using the numeric data entry keys 288, and instruct the device 200 to record the balance by pressing the enter key 224.

In some embodiments, a deposit to an account, such as a checking account, may be recorded by pressing the appropriate account key (i.e., the checking/debit/ATM key 252) to identify the account, pressing the deposit key 228 to indicate that the transaction involves a deposit, entering the amount of the deposit by using the numeric data entry keys 288, and pressing the enter key 224 to instruct the device 200 to record the deposit and increase the account balance.

In some embodiments, a user may record the writing of a check or the use of a debit card to make a purchase by pressing the check/debit/ATM key 252 to indicate the transaction involves a checking account, pressing an expense category key to indicate that the transaction is an expense and to indicate the category of the expense (by, for example, pressing the fun key 278), using the numeric data entry keys 288 to enter the amount of the transaction and using the enter key 224 to instruct the device 200 to record the transaction, increase the amount of the corresponding expense category by the amount of the transaction, and decrease the amount of the checking account balance by the amount of the transaction. In some embodiments, the user may enter the amount of the transaction using the numeric data entry keys 288 before pressing an expense category key.

In some embodiments, a user may record a transaction code (such as a check number) when entering a transaction. For example, a user may record a transaction involving the writing of a check by pressing the check/debit/ATM key 252 to indicate the transaction involves a checking account, using the numeric data entry keys 288 to enter the amount of the transaction, pressing an expense category key to indicate that the transaction is an expense and to indicate the category of the expense (by, for example, pressing the personal care key 268), using the numeric data entry keys 288 to enter the transaction code, and using the enter key 224 to instruct the device 200 to record the transaction and code, increase the amount of the corresponding expense category by the amount of the transaction, and decrease the amount of the checking account balance by the amount of the transaction.

In some embodiments, a user may record a withdrawal of cash from a checking account by pressing the checking/debit/ATM key 252 to indicate the transaction involves the checking account, using the numerical input keys 288 to enter the amount of the withdrawal, pressing the cash key 250 to indicate the transaction is a transfer to cash, and pressing the enter key to instruct the device 200 to record the transaction, reduce the balance of the checking account by the amount of the withdrawal and increase the amount of the cash balance by the amount of the transaction.

In some embodiments, an account balance can be obtained by pressing the appropriate account key (i.e., the checking/debit/ATM key 252, the credit key 248, or the cash key 250), pressing the balance key 230, and pressing the enter key 224, causing the device 200 to display the account balance on the display 206. In some embodiments, the total key 232 may be pressed instead of the enter key 224.

In some embodiments, a total of the check/debit/ATM purchases and/or withdrawals stored in the device 200 may be obtained by pressing the check/debit/ATM key 252 followed by the total key 232.

In some embodiments, a credit balance (such as a charge card balance) may be entered by pressing the credit key 248, using the numerical data entry keys 288 to enter the balance, and pressing the enter key 224 to instruct the device 200 to record the credit balance. In some embodiments, a payment or a refund may be recorded to a credit balance by pressing the credit key 248, using the numeric data entry keys 288 to enter the amount, pressing the deposit key 228 to indicate the transaction is a payment or refund, and pressing the enter key 224 to instruct the device 200 to record the transaction and reduce the credit balance by the amount of the transaction.

In some embodiments, a credit purchase (such as a charge card purchase) may be entered by pressing the credit key 248, using the numeric data entry keys 288 to enter the amount of the transaction, pressing an expense category key (i.e., the travel key 266) to indicate the expense category, and pressing the enter key 224 to cause the device 200 to record the transaction. In some embodiments, the device 200 would record the transaction by increasing a stored credit balance by the amount of the purchase, and increasing a stored total for the expense category by the amount of the purchase.

In some embodiments, the total amount of the transactions for an account for a period of time can be found by pressing a key to select the account (i.e., the checking/debit/ATM key 252, the cash key 250, or the credit key 248), pressing the days key 244 to indicate the data over a period of time is desired, using the numeric data entry keys 288 to enter the number of days (e.g., 1-31), and pressing the total key 232 to cause the device 200 display the total amount of the transaction for the selected account over the prior selected number of days on the display 206.

In some embodiments, the total cash balance may be entered by pressing the cash key 250, using the numeric data entry keys 288 to enter the amount of cash on hand, and pressing the enter key 224. In some embodiments, an increase in the amount of cash on hand may be recorded by pressing the cash key 250, pressing the deposits key 228, using the numeric data entry keys 288 to enter the amount of the increase, and pressing the enter key 224.

In some embodiments, a cash purchase may be recorded by pressing the cash key 250, using the numeric data entry keys 288 to enter the amount of the purchase, pressing an expense category key (i.e., the clothes key 260), and pressing the enter key 224, to cause the device to decrease the cash balance by the amount of the purchase and increase the expense category total by the amount of the purchase.

In some embodiments, the total amount of the stored transactions for an expense category can be obtained by pressing the desired expense category key (i.e., the dining key 258), and pressing the total key 232, causing the device 200 to display the total amount of spending in the expense category. In some embodiments, the total spending in an expense category over a period of time can be obtained by pressing the desired expense category key (i.e., the phone key 282), pressing the days keys 244, using the numeric data entry keys 288 to enter the desired number of days (e.g., 1-31) and pressing the total key 232 to cause the device 200 to display the total spending in the desired category over the total number of desired days.

Additional illustrative examples of the operation of a device for recording financial transactions are described below with reference to the embodiment of the device 300 of FIG. 3.

In some embodiments, a user may clear all entries and data records stored in the device 300 by depressing the clear-all key 326 for a threshold period of time. In some embodiments, the threshold period of time is three seconds. In some embodiments, the device 300 may be configured to request confirmation of a clear-all command by displaying a confirmation request on the display 302.

In some embodiments, a user may cause the device 300 to clear a balance in a particular account by pressing the clear-all key 326, pressing the account key (i.e., the bank key 362), and pressing the enter key 324. In some embodiments, a user may turn the device 300 off by pressing the off key 320. The device 300 may be configured to continue to store all data while in off mode.

In some embodiments, the device 300 may be configured to store budgeted amounts associated with expense categories. In some embodiments, a user may cause the device 300 to store budgeted amounts for an expense category by pressing the budget key 358, pressing the balance key 330, pressing an expense category key (i.e., the dining key 366), entering the budgeted amount using the numeric data entry keys 390, and pressing the enter key 324. In some embodiments, a user may cause the device 300 to display the amount left in a budget for an expense category by pressing the budget key 358, pressing the balance key 330, pressing an expense category key (i.e., the dining key 358), and pressing the enter key 324.

In some embodiments, a user may cause the device 300 to record an expense by pressing an account key (i.e., the credit card key 350 or the checking/debit key 356), entering the amount of the expense using the numeric data entry keys 390, pressing an expense category key (i.e., the dining expense key 366), and pressing the enter key 324. In some embodiments, the device 300 is configured to record an expense by adjusting the appropriate account balance (i.e., by increasing a credit card balance or decreasing a checking balance), reducing a budgeted balance for an expense category (i.e., by reducing a balance budgeted for dining expenses), and increasing a balance for expenditures in an expense category (i.e., by increasing a total for dining expenses).

In some embodiments, a user may cause the device 300 to store a bank account balance by pressing the bank key 362, pressing the balance key 330, entering the balance using the numeric data entry keys 390, and pressing the enter key 324. For example, a user may wish to enter a bank account balance upon receiving a monthly statement. In some embodiments, a user may cause the device 300 to display a bank account balance by pressing the bank key 362, pressing the balance key 330 and pressing the total key 332. In some embodiments, when a user enters a purchase using the checking/debit key 356, this will cause the device 300 to deduct the amount of the purchase from a stored bank account balance.

In some embodiments a user may cause the device 300 to record a cash withdrawal from an ATM machine by pressing the ATM key 352, using the numeric data entry keys 390 to enter the amount of the withdrawal, pressing the cash key 354, and pressing the enter key 324. In some embodiments, pressing of the cash key 354 may be omitted from the sequence. In some embodiments, recording of the cash withdrawal by the device 300 includes reducing a stored bank balance by the amount of the withdrawal and increasing a stored cash balance by the amount of the transaction.

In some embodiments, a user may cause the device 300 to record a cash deposit to a bank account by pressing the bank key 362, pressing the deposit key 328, entering the amount of the deposit using the numeric data entry keys 390, and pressing the enter key 324. In some embodiments, recording of the deposit by the device 300 includes increasing a stored bank balance by the amount of the deposit.

In some embodiments, the device 300 is configured to respond to activation of the clear entry/on key 322 during entry of a data sequence by deleting a portion of the sequence entered. In some embodiments, repeated activation of the clear entry/on key 322 before an entry of a data sequence is complete may cause the device 300 to back out of an entered data sequence one step for each activation of the clear entry/on key 322.

In some embodiments, a user may cause the device 300 to display the total expenditures in an expense category by pressing an expense category key (i.e., the fun key 378), pressing the balance key 330, and pressing the total key 332.

In some embodiments, a user may cause the device 300 to record a cash balance (for example, cash on hand at the beginning of a month) by pressing the cash key 354, using the numeric data entry keys 390 to enter the amount of the cash balance, pressing the balance key 330, and pressing the enter key 324.

In some embodiments, a user may cause the device 300 to record a cash deposit using an ATM by pressing the ATM key 352, using the numeric data entry keys 390 to enter the amount of the deposit, pressing the deposit key 328 and pressing the enter key 324.

In some embodiments, a user may cause the device 300 to record a savings balance (i.e., a balance at the beginning of a month or a beginning balance) by pressing the savings key 360, pressing the balance key 330, using the numeric data entry keys 390 to enter the balance, and pressing the enter key 324. In some embodiments, a user may cause the device 300 to record a savings deposit by pressing the savings key 360, pressing the deposit key 328, using the numeric data entry keys 390 to enter the amount of the deposit, and pressing the enter key 324.

In some embodiments, a user may cause the device 300 to record a withdrawal from savings to obtain cash by pressing the savings key 360, using the numeric data entry keys 390 to record the amount of the withdrawal, pressing the cash key 354 and pressing the enter key 324. In some embodiments, recording of the withdrawal by the device 300 includes reducing a savings balance by the amount of the withdrawal and increasing a cash balance by the amount of the withdrawal.

In some embodiments, a user may cause the device 300 to record a transfer from a savings account to a bank account by pressing the savings key 360, using the numeric data entry keys 390 to enter the amount of the transfer, pressing the bank key 362, and pressing the enter key 324. In some embodiments, recording of the transfer by the device 300 includes reducing a savings balance by the amount of the transfer and increasing a bank account balance by the amount of the transfer.

In some embodiments, a user may cause the device 300 to record a payment from a savings account to a credit card by pressing the savings key 360, using the numeric data entry keys 390 to enter the amount of the payment, pressing the credit card key 350, and pressing the enter key 324. In some embodiments, recording of the payment by the device 300 includes reducing a savings balance by the amount of the payment and reducing a credit card balance by the amount of the payment.

In some embodiments, a user may cause the device 300 to store a credit card balance by pressing the credit card key 350, pressing the balance key 330, using the numeric data entry keys 390 to enter the credit card balance, and pressing the enter key 324. In some embodiments, a user may cause the device 300 to display a credit card balance by pressing the credit card key 350, pressing the balance key 330, and pressing the total key 332.

In some embodiments, a user may cause the device 300 to record a credit card purchase by pressing the credit card key 350, using the numeric data entry keys 390 to enter the amount of the purchase, pressing a category key (i.e., the dining key 366), and pressing the enter key 324. In some embodiments, recording of the credit card purchase by the device 300 includes increasing a credit card balance by the amount of the purchase, increasing a category expense balance by the amount of the purchase, and decreasing a category budget balance by the amount of the purchase.

In some embodiments, a user may cause the device 300 to display a total of the expenses recording in an expense category over a period of days by pressing the appropriate category key (i.e., the house hold key 384), pressing the day key 346, using the numeric data entry keys 390 to enter the desired number of days, and pressing the total key 332.

In some embodiments, a user may cause the device 300 to display a total of the amount of purchases using cash over a period of time by pressing the cash key 354, pressing the day key 346, using the numeric data entry keys 390 to enter the desired number of days, and pressing the total key 332. In some embodiments, a user may cause the device 300 to display a total of the amount of the charges to a credit card over a period of time by pressing the credit card key 350, pressing the day key 346, using the numeric data entry keys 390 to enter a desired number of days, and pressing the total key 332. In some embodiments, a user may cause the device 300 to display a total of the amount of withdrawn from a checking account over a period of time by pressing the checking/debit key 356, pressing the day key 346, using the numeric data entry keys 390 to enter the desired number of days, and pressing the total key 332.

In some embodiments, the keys may be pressed in different orders than the orders presented in the above examples, or fewer keys may be required to perform certain transactions. For example, an account balance in the embodiment illustrated in FIG. 2, such as a checking account balance from a monthly banking statement could also be set by having a user press the checking/debit/ATM key 252 to identify the account, enter the balance amount using the numeric data entry keys 288, press the balance key 230 to indicate that the transaction involves a balance, and instruct the device 200 to record the balance by pressing the enter key 224. In another example, the device 200 may be configured to use defaults. For example, in the absence of entering an expense category or pressing the balance key, the device 200 may be configured to assume a checking transaction is a cash ATM withdrawal. In such an embodiment a withdrawal of cash from a checking account may be performed by pressing the checking/debit/ATM key 252 to indicate the transaction involves the checking account, using the numerical input keys 288 to enter the amount of the withdrawal, and pressing the enter key 224 to instruct the device 200 to record the transaction, reduce the balance of the checking account by the amount of the withdrawal and increase the amount of the cash balance by the amount of the transaction.

Embodiments of devices for recording financial information that do not contain expensive interfaces to other devices (such as radio-frequency communication systems, external data bus interfaces, etc.), and that are not designed to provide significant programming capabilities (which require substantial amounts of memory and expensive processors), such as assignable keys, scheduling functions, etc., may be advantageously employed in a number of applications. The low cost and high portability of such embodiments facilitates their use in training programs, such as programs to teach high school students or other target audiences, budgeting skills. Such embodiments may also be advantageously employed by travelers, for example, to keep track of expenses and resources while on vacation.

From the foregoing it will be appreciated that, although specific embodiments of the invention have been described herein for purposes of illustration, various modifications may be made without deviating from the spirit and scope of the invention. Accordingly, the invention is not limited except as by the appended claims and the equivalents thereof.

1. A device for recording financial transactions, comprising:
a housing;
a control system coupled to the housing and having a memory;
a display coupled to the housing; and
an input system coupled to the housing, the input system comprising:
a plurality of manual switches configured to receive function data;
a plurality of manual switches configured to receive account selection data;
a plurality of manual switches configured to receive category selection data; and
a plurality of manual switches configured to receive numerical data.

2. The device of claim 1 wherein the control system comprises an eight-bit processor.

3. The device of claim 1 wherein the control system comprises a sixteen-bit processor.

4. The device of claim 1 wherein the input system comprises a plurality of keys on a keypad.

5. The device of claim 4 wherein the plurality of switches configured to receive category selection data comprises a portion of the plurality of keys on the keypad.

6. The device of claim 5 wherein categories associated with the category selection keys on the keypad are fixed.

7. The device of claim 1 wherein the device is configured to perform calculator functions.

8. The device of claim 4 wherein the keys on the keypad are not re-assignable.

9. The device of claim 1 wherein the plurality of switches configured to receive function data comprises:
an off key;
an on/CE key;
an enter key;
a clear-all key;
a deposit key;
a balance key;
a total key;
an addition key;
a subtraction key;
a multiplication key; and
a division key.

10. The device of claim 9, wherein the plurality of switches configured to receive function data further comprises:
a percent key; and
a day key.

11. The device of claim 1 wherein the plurality of switches configured to receive account selection data comprises:
a credit account selection key;
an ATM account selection key;
a cash account selection key;
a checking/debit account selection key; and
a budget account selection key.

12. The device of claim 1 wherein the plurality of switches configured to receive category selection data comprises:
a fun category selection key;
a clothing category selection key;
a housing category selection key;
a personal care category selection key;
a grocery category selection key;
a utilities category selection key; and
a transportation category selection key.

13. A method of recording a financial transaction performed by a computing device, the method comprising:
receiving a financial transaction input sequence associated with the financial transaction from a plurality of keys on a keypad of the computing device;
associating an account with the financial transaction based on the received financial transaction input sequence;
associating an expense category with the financial transaction based on the received financial transaction input sequence;
displaying information associated with the financial transaction on a display of the computing device; and
storing information associated with the financial transaction in a memory of the computing device, the stored information including a reference to the associated account and a reference to the associated expense category.

14. The method of claim 13, further comprising:
clearing the stored information from the memory in response to a clear input sequence received from the keypad of the computing device.

15. The method of claim 13, further comprising:
performing a calculator function in response to a calculator input sequence received from the keypad of the computing device.

16. The method of claim 13 wherein the storing information associated with the financial transaction in the memory of the computing device comprises storing the information in a data record in the memory of the computing device.

17. A device for recording financial transactions, comprising:
a housing;
means for receiving a financial transaction input sequence associated with the financial transaction coupled to the housing;
means for associating an account with the financial transaction based on the received financial transaction input sequence contained within the housing;
means for associating an expense category with the financial transaction based on the received financial transaction input sequence contained within the housing;
means for displaying information associated with the financial transaction coupled to the housing; and
means for storing information associated with the financial transaction contained within the housing, the stored information including a reference to the associated account and a reference to the associated expense category.
